(19) United States
(12) Patent Application Publication
(10) Pub. No.: US 2024/0341421 A1
(43) Pub. Date: Oct. 17, 2024

(54) ITEM OF JEWELLERY

(71) Applicant: Paspaley Pearls Pty Ltd., Darwin City, Northern Territory (AU)

(72) Inventor: Sebastian KAPPEN, Darwin City (AU)

(21) Appl. No.: 18/682,690

(22) PCT Filed: Aug. 9, 2022
(86) PCT No.: PCT/AU2022/050862

§ 371 Date: Feb. 9, 2024

(30) Foreign Application Priority Data
Aug. 10, 2021 (AU) 2021215144

(51) Int. Cl. A44C 17/04

(52) U.S. Cl. CPC A44C 17/046

(57) ABSTRACT

An item of jewellery (10) including a gemstone (20) and a substrate (40). The gemstone (20) defines a peripheral region (22). The substrate (40) defines a plurality of apertures (42) spaced in locations arranged relative to the peripheral region (22), each aperture (42) dimensioned to receive a respective post (30). The posts (30) are secured in the apertures (42) to extend from the substrate (40) and against the peripheral region (22) of the gemstone (20) to mount the gemstone (20) on the substrate (40). A method for mounting a gemstone (20) to a substrate (40) is also disclosed.

### TECHNICAL FIELD

The present disclosure relates, generally, to jewellery and, particularly, to items of jewellery including a gemstone mounted to a substrate.

### BACKGROUND

Jewellery making often involves mounting one or more gemstones in, or on, a substrate, such as precious metal, pearl, pearl nacre, or composite material, such as carbon fibre. This typically involves drilling or otherwise forming a recess in the substrate. The recess is dimensioned to substantially receive the gemstone. The gemstone is then either placed in the recess and bonded directly to the substrate with adhesive, or fixed in a metallic mount and the mount placed in the recess and bonded to the substrate with adhesive. These approaches can cause excessive and unsightly damage to the substrate and are prone to allowing the gemstone to detach from the substrate due to the adhesive failing. Also, the adhesive may discolour over time, and/or the arrangement of the gemstone in the recess can inhibit lustre of the gemstone, either of which detracts from the aesthetic appeal of the item of jewellery.

Any discussion of documents, acts, materials, devices, articles or the like which has been included in the present specification is not to be taken as an admission that any or all of these matters were common general knowledge in the field relevant to the present disclosure as it existed before the priority date of each of the appended claims.

### SUMMARY

According to some disclosed embodiments, there is provided an item of jewellery including a gemstone defining a peripheral region, a plurality of posts, and a substrate defining a plurality of apertures spaced in locations arranged relative to the peripheral region, each aperture dimensioned to receive a portion of one of the posts. The posts are secured in the apertures to extend from the substrate and against the peripheral region to mount the gemstone on the substrate.

In some embodiments, the gemstone may define an axis of symmetry. Each aperture may extend transversely to the axis. Alternatively, or additionally, the gemstone may define a plane of symmetry, and each aperture may extend transversely to the plane.

The substrate may have a notional mount region corresponding with the peripheral region of the gemstone. The apertures may be arranged to be at least partially within the notional mount region of the substrate. In some embodiments, the apertures may be arranged in a regular array about the notional mount region.

A recess may be defined within the notional mount region. The recess may be shaped to partially receive the gemstone.

Each post may be shaped to trap a portion of the peripheral region. For example, each post may define an engaging portion configured to engage with the peripheral region of the gemstone. Each engaging portion may include a notch shaped to receive part of the peripheral region.

The gemstone may define a table facet, and the posts may be arranged to mount the table facet substantially parallel to the substrate.

Each aperture may be configured to frictionally engage one of the posts to retain the post to the substrate. Additionally or alternatively, one or more of the apertures may carry adhesive configured to bond the post to the substrate.

According to some disclosed embodiments, there is provided an item of jewellery including: a plurality of gemstones, each gemstone defining a peripheral region; a plurality of sets of posts; and a substrate defining a plurality of sets of apertures, each set of apertures having the apertures spaced in locations arranged relative to the peripheral region of one of the gemstones, each aperture dimensioned to receive a portion of one of the posts, where each set of posts are secured in one of the sets of apertures to extend from the substrate and against the peripheral region of one of the gemstones to mount the gemstone to the substrate.

The substrate may define a curved surface, and each aperture may be defined in the curved surface. In some embodiments the substrate defines a double curved surface. For example, the substrate may define a substantially spherical structure. Alternatively, the substrate may define a substantially planar, or flat, surface, and each aperture may be defined in the substantially planar surface. In some embodiments, the substrate is a pearl. In other embodiments, the substrate is nacre.

According to some disclosed embodiments, there is provided a method of mounting a gemstone defining a peripheral region to a substrate, the method including: selecting a notional mount region on the substrate, the notional mount region substantially corresponding to the peripheral region of the gemstone; selectively removing material from the substrate to define a plurality of holes in the substrate, the holes spaced in locations arranged relative to the notional mount region; fixing a post in each hole such that a portion of the post is engaged with the substrate, and the post extends from the substrate; and arranging the peripheral region of the gemstone against each of the posts such that the gemstone is retained within the posts.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated embodiments may comprise steps, features and/or integers disclosed herein or indicated in the specification of this application individually or collectively, and any and all combinations of two or more of said steps or features.

### BRIEF DESCRIPTION OF DRAWINGS

Embodiments will now be described by way of example only with reference to the accompanying drawings in which:

FIG. 1 is a detailed view of an item of jewellery including a plurality of gemstones mounted to a pearl substrate;

FIGS. 2 to 4 are detailed views illustrating three stages of mounting a gemstone to a curved substrate;

FIGS. 5 and 6 are cross-section and top views, respectively, of the gemstone mounted to the curved substrate shown in FIG. 4; and

FIG. 7 is a schematic gemstone layout of the item of jewellery of FIG. 1.

### DESCRIPTION OF EMBODIMENTS

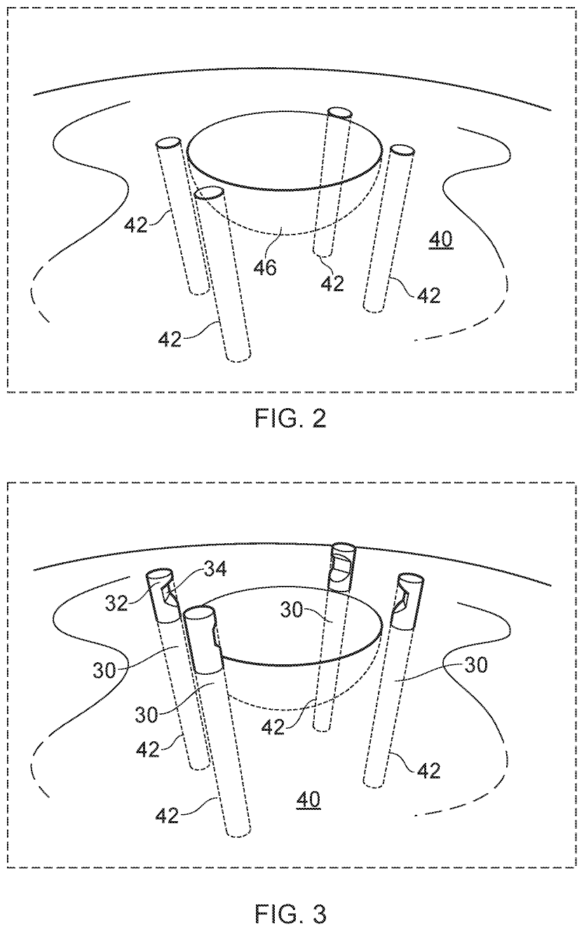

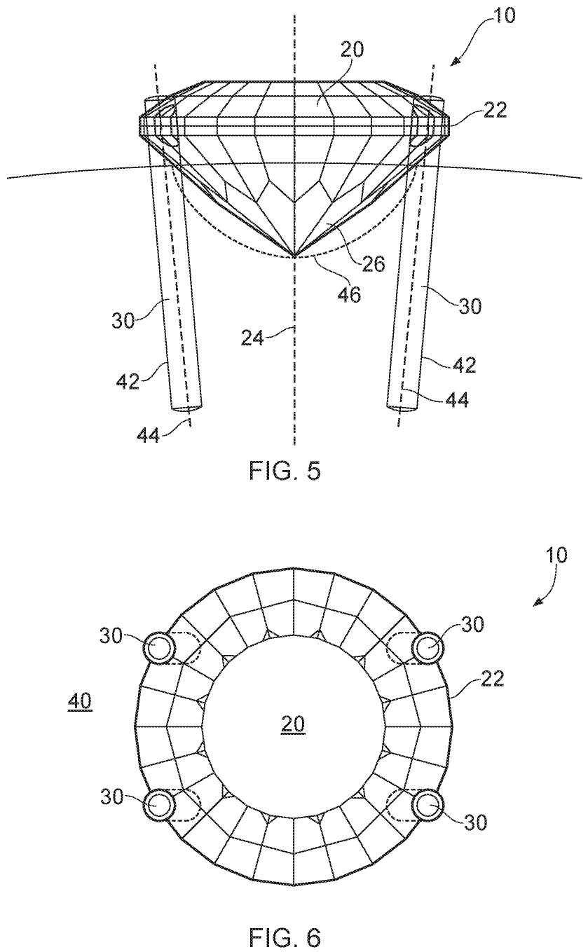

In the drawings, reference numeral 10 generally designates an item of jewellery according to the present disclosure. The item of jewellery 10 includes a gemstone 20, a plurality of posts 30 and a substrate 40. The gemstone 20 defines a peripheral region 22 (FIG. 5). The substrate 40 defines a plurality of apertures 42 (FIG. 2) spaced in locations arranged relative to the peripheral region 22. Each aperture 42 is dimensioned to a portion of one of the posts 30. The posts 30 are secured in the apertures 42 to extend from the substrate 40 and against the peripheral region 22 to mount the gemstone 20 on the substrate 40.

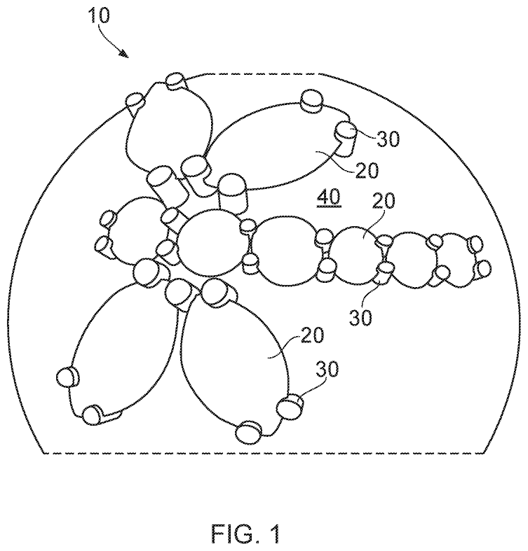

As shown in FIG. 1, in some embodiments, the item of jewellery 10 may include a plurality of gemstones 20, each gemstone 20 defining a peripheral region 22. In such embodiments, a plurality of sets of posts 30 is provided, and the substrate 40 defines a plurality of sets of apertures 42, each set of apertures 42 having the apertures 42 spaced in locations arranged relative to the peripheral region 22 of one of the gemstones 20, and each aperture 42 dimensioned to receive a portion of one of the posts 30. Each set of posts 30 are secured in one of the sets of apertures 42 to extend from the substrate 40 and against the peripheral region 22 of one of the gemstones 20 to mount the gemstone 20 to the substrate 40.

Best shown in FIG. 5, the gemstone 20 may define an axis of symmetry 24. Gemstone cuts defining an axis of symmetry 24 include, but are not limited to, round, princess, rose, half rose, radiant, brilliant, cushion, square, ball, trillion, French, or other cuts having rotational symmetry. Alternatively, or additionally, the gemstone 20 may define one or more planes of symmetry, such as aligned with the axis 24 shown in the figures. Gemstone cuts defining a plane of symmetry may include, but are not limited to, pear, rectangular, trapeze, navette, oval, pendeloque or other cuts having reflectional symmetry.

The posts 30 may be arranged such that the axis 24 of the gemstone 20 is positioned to be substantially perpendicular to the local surface of the substrate 40. Where the substrate 40 defines a spherical structure, the axis of symmetry 24 (or plane of symmetry), of the gemstone 20 may be positioned to extend towards a centre of the sphere.

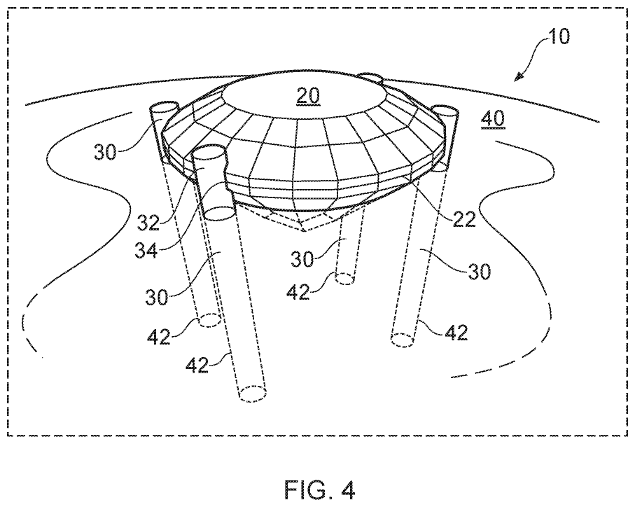

In some embodiments, such as illustrated in FIGS. 4 to 6, the gemstone defines a table facet 21, typically being a flat crown surface of the stone 20. In such embodiments, the posts 30 may be arranged to position the table facet 21 to be substantially parallel to the local surface of the substrate 40. In other embodiments (not illustrated), the posts 30 are arranged to position the table facet 21 at an angle relative to the substrate 40, such as tilting towards the substrate 40. In other embodiments, the gemstone may define other shapes. For example, the gemstone may have a rounded top surface, such as a cabochon gemstone, and the posts 30 be arranged to mount the rounded top relative to the substrate 40.

Each aperture 42 may be arranged to extend transversely, being at a non-zero angle, to the axis of symmetry 24, or plane of symmetry, of the gemstone 20. In the illustrated embodiment, the apertures 42 are in the form of elongate holes, each having a respective aperture axis 44. The holes are typically formed by drilling however it will be appreciated that other approaches to selectively remove material from the substrate 40, such as laser cutting, are within the scope of this disclosure. Where the substrate 40 defines a curved surface, the axis 44 may be arranged to be substantially perpendicular to the local surface of the substrate 40. Where the substrate 40 defines a spherical structure, the axis 44 may be arranged to extend towards a centre of the sphere.

As can be appreciated from FIG. 5, in the illustrated embodiment, the aperture axes 44 are each arranged at a predetermined acute angle relative to the gemstone axis of symmetry 24 and mirrored about a plane of symmetry aligned with the axis 24. The aperture axes 44 may extend at a predetermined angle to the axis of symmetry 24, or a plane of symmetry. For example, the angle may be between about 3 degrees to about 5 degrees. The angle may depend on the size and/or shape of the gemstone 20. For example, in some embodiments (not illustrated), the angle of the aperture axes 44 arranged about a gemstone 20 may vary depending on the position of the aperture 40 relative to the peripheral region 22 of the stone 20.

Typically, each aperture 42 is dimensioned to frictionally engage one of the posts 30. This forms an interference fit between a portion of each post 30 and the substrate 40 to firmly engage the post 30 with the substrate 40. Additionally or alternatively, one or more of the apertures 42 carries adhesive configured to bond the post 30 to the substrate 40.

Each post 30 may be shaped to trap a portion of the peripheral region 22 of the gemstone 20. For example, in the illustrated embodiment and best shown in FIG. 3, each post 30 may define an engaging portion 32 configured to engage with the peripheral region 22. In this embodiment, the engaging portion 32 includes a notch 34. The notch 34 is shaped to receive part of the peripheral region 22 of the gemstone 20, as shown in FIG. 4. In other embodiments (not illustrated), the engaging portion 32 may include a hook, tab, claw, or other structure configured to interlock or grip the peripheral region 22 to secure the gemstone 20. In some embodiments (not illustrated), each engaging portion 32 may include a resiliently deformable portion, such as a silicone pad, arranged to be deformed by, and grip, the peripheral region 22 of the gemstone 20.

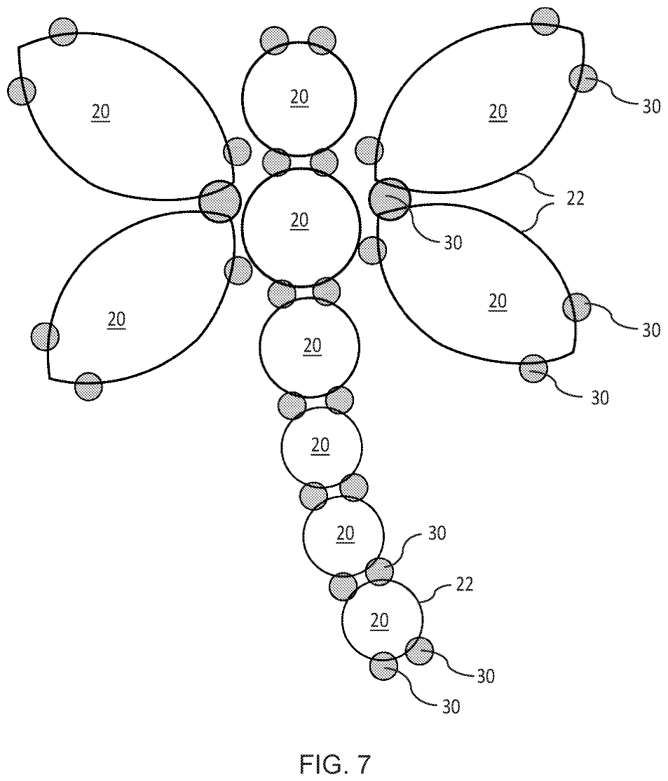

In embodiments including a plurality of gemstones 20, such as shown in FIGS. 1 and 5, one or more posts 30 may be shaped to trap a portion of the peripheral region 22 of more than one gemstone 20. FIG. 7, for example, shows some posts 30 which engage only one gemstone 20 while other posts 30 engage two gemstones 20. Other embodiments (not illustrated) may include posts 30 configured to engage three or more gemstones 20. Posts 30 which engage a plurality of gemstones 20 may have a specifically configured engaging portion 32 including, for example, a corresponding plurality of notches 34 or other retention structure, such as described above.

Referring again to FIG. 5, when the posts 30 are secured in respective apertures 42, at least the portion of each post 30 inserted into the substrate 40 is aligned with the respective aperture axis 44. A first portion of each post 30 is received in a respective aperture 42, such that a second portion of each post 30 extends from the substrate 40. The second portion of each post 30 is typically dimensioned to be shorter than the first portion of the post 30. For example, the second portion of the post 30 may be approximately 25% of a length of the post 30. The length of the second portion of the post 30 may depend on the size of the gemstone 20 and/or a girdle thickness of the gemstone 20 about the peripheral region 22. The second portion of the post 30 extending from the substrate 40 may be selected to be greater than a predefined minimum value required to engage the gemstone 20. For example, for gemstones 20 ranging from about 1.2 mm to about 5 mm in height, the portion of the post 30 extending from the substrate 40 may range from about 4 mm to about 6 mm. In the embodiment 10 shown in FIG. 5, the second portion of the post 30 extending from the substrate 40 is about 5 mm.

When a gemstone 20 is mounted in the substrate 40, the posts 30 and gemstone 20 may lock together as a unit such that the opposing angles of the posts 30 inhibit withdrawal of the posts 30 from the substrate 40. In this way, the angular arrangement of the posts 30 relative to the gemstone 20 and substrate 40 can enhance retaining the gemstone 20 to the substrate 40.

The substrate 40 may have a notional mount region. The mount region is a notional profile defined on the external surface of the substrate 40. The profile substantially corresponds with the peripheral region 22 of the gemstone 20, such as a projection of the peripheral region 22 when arranged adjacent the substrate 40. The apertures 42 are typically arranged to be at least partially within the notional mount region of the substrate 40. For example, as shown in FIG. 6, the apertures 42 are arranged to extend within the notional mount region of the substrate 40, as indicated by the dotted lines. In some embodiments, the apertures 42 are arranged to extend generally towards the centre of the notional mount region, which typically is aligned with the axis of symmetry of the gemstone 20. The arrangement of the apertures 42 means that, when the gemstone 20 is mounted on the substrate 40, the apertures 42 are substantially hidden beneath the gemstone 20. In other embodiments, such as shown in FIG. 1, the apertures 42 may be arranged to be at least partially outside of the notional mount region. In these embodiments, the apertures 42 may extend away from the centre of the notional mount region. This configuration may be used, for example, where the shape of the gemstone 20 inhibits arranging the apertures 42 within the mount region.

In the embodiment as shown in FIG. 6, the apertures 42 are arranged in a regular array about the notional mount region of the substrate 40. It will be appreciated that the apertures 42 may alternatively be arranged in an irregular array about the notional mount region. In some embodiments including a plurality of gemstones 20 mounted to the substrate 40, such as shown in FIG. 1, a combination of regular and irregular arrays of apertures 42 are defined in the substrate 40. FIG. 7 shows the outline of each post 30 arranged relative to the peripheral region 22 of each gemstone 20.

Referring to FIG. 2, in the illustrated embodiment a recess 46 is defined in the substrate 40 and shaped to partially receive the gemstone 20. In the illustrated embodiments, best shown in FIG. 5, the recess 46 is configured to receive a base portion of the gemstone 20, known as the cullet. A depth of the recess 46 may be configured relative to an overall height of the gemstone 20, such that a predetermined portion of the gemstone 20 remains above a surface level of the substrate 40 when the gemstone is mounted to the substrate 40. For example, in some embodiments, a depth of the recess 46 is configured such that at least 20%, at least 30%, at least 40%, at least 50%, at least 60%, at least 70%, at least 80% or at least 90% of the gemstone 20 remains above a surface level of the substrate 40 when the gemstone 20 is mounted to the substrate 40. The depth of the recess 46 may be configured such that the peripheral region 22 of the gemstone 20 is positioned a predetermined distance above the surface level of the substrate 40 when the gemstone 20 is mounted to the substrate. It will be appreciated that in other embodiments the recess 46 is absent and the gemstone 46 is mounted on, or adjacent to, an external surface of the substrate 40.

In some embodiments, for example as can be appreciated in FIGS. 3 and 5, the recess 46 may be contained wholly within the notional mount region. In such embodiments, the recess 46 is hidden when the gemstone 20 is mounted to the substrate 40.

In the illustrated embodiments, the substrate 40 is a pearl and the apertures 42 are drilled into the curved surface of the pearl substrate 40. The pearl substrate 40 typically defines a substantially spherical structure having double-curved external surfaces in which the apertures 42 are defined. In some embodiments, the surface of the substrate 40 is singularly curved. The gemstone 20 may gain lustre and brilliance from the pearl substrate 40 as the gemstone 20 reflects and refracts colour from the substrate 40. It will be appreciated that the disclosed item of jewellery 10 and method for mounting a gem 20 to a substrate 40 is applicable to other substrate materials and structures, including planar surfaces. For example, in other embodiments (not illustrated), the substrate 40 may be singularly curved, such as a region of a ring, double-curved and undulating, such as a portion of an earring, planar, faceted, or a combination of two or more of these structures. Furthermore, in some embodiments (not shown), the substrate 40 comprises pearl nacre, precious metal such as gold, or a composite material, such as carbon fibre, or a combination of materials.

FIGS. 2 to 4 illustrate a method of mounting one or more gemstones 20 to a substrate 40 to fabricate an item of jewellery 10 according to the present disclosure. The method includes initially selecting a notional mount region on the substrate 40. The notional mount region substantially corresponds to the peripheral region 22 of the gemstone 20. Selecting the region may involve virtual or physical marking of the substrate, for example, by projecting the region onto the substrate with light.

Referring to FIG. 2, a plurality of holes are formed in the substrate 40 to define apertures 42, typically by drilling the substrate 40. The holes/apertures 42 are spaced in specific locations arranged relative to the notional mount region, which is based on an intended position of the peripheral region 22 of the gemstone 20 relative to the substrate 40. Locations for the holes/apertures 42 may be marked on the substrate 40 prior to drilling. For example, a scale stone setting map, such as that shown in FIG. 7, may be generated and overlaid on the substrate to define aperture 42 placement, such as by applying a printed form, applying pigment, or projecting light on to the substrate 40. Additionally or alternatively, gemstones 20 may be placed reverse side up on the substrate 40 to determine aperture 42 placement. Aperture 42 placement may be marked on the substrate 40 by viewing the substrate 40 under a microscope and using a fine pen or similar marking tool, for example. Alternatively, in some embodiments, laser guided or CNC marking and/or drilling is employed.

As shown in FIG. 3, a post 30 is then arranged in each hole 42. Typically, the hole 42 is dimensioned such that urging the post 30 into the hole 42 causes a portion of the post 30 to be frictionally engaged with the substrate 40, and the post 40 to extend from the substrate 40. In some embodiments, the hole 42 is dimensioned to have a clearance with the post 30 and carries the adhesive to cause bonding between the post 30 and substrate 40. In yet other embodiments, the hole 42 is dimensioned to cause frictional engagement and carries the adhesive.

As shown in FIG. 4, the gemstone 20 is arranged within a boundary defined by the posts 40 such that the peripheral region 22 of the gemstone 20 is arranged against each of the posts 30 to retain the gemstone 20 within the posts 30.

In embodiments including a plurality of gemstones 20 mounted to a substrate, the method may include drilling sets of apertures 42, each set comprising a plurality of apertures 42 arranged relative to the notional mount region for a gemstone 20. A complementary plurality of sets of posts 30 are then fixed in the sets of holes 42 such that a portion of each post 30 is secured to the substrate 40 and the post 30 extends from the substrate 40. The peripheral region 22 of each gemstone 20 may then be arranged against each of the posts 30 in one of the sets such that the gemstone 20 is retained within the set of posts 30.

It will be appreciated that, in practice, the steps of the described methods may be executed in a different order to that described above and illustrated in FIGS. 2-4, and can include additional steps. For example, for some applications, the gemstone 20 is arranged adjacent the substrate 40 prior to fixing the posts 40 in the apertures 42. For some embodiments, the method may include forming the recess 46 in the substrate 40.

The item of jewellery 10 and method according to the present disclosure may allow securely mounting a gemstone 20 to a substrate 40, such as pearl, to enhance durability of the item 10. For example, frictional engagement and/or bonding of the posts 30 to the substrate 40 and pressed against the gemstone 20 can firmly retain the stone 20 to the substrate 40 for a considerable period of time. Furthermore, the posts 30 may be arranged relative to the substrate 40 and gemstone 20 to withstand considerable force before deformation, or otherwise failing, which would allow removal of the stone 20 from the substrate 40.

The disclosed item of jewellery 10 may enhance gemstone 20 lustre and brilliance by optimising the arrangement of the gemstone 20 relative to the substrate 40. Gemstones, particularly diamonds, receive and reflect surrounding light. Traditional precious metal mounts are highly polished before setting to minimise any dulling effect on the appearance of mounted gemstones. While stones set in metal allow some light to be reflect from the gemstone, the stone is typically shaded by the metal underneath. The disclosed item of jewellery 10 minimises metal adjacent the stone 20 by requiring only a few discrete posts 30. As a result, the colour and intensity of light reflected by the gemstone 20 may be enhanced, for example, because of the position and/or orientation of the stone 20 relative to the substrate 40, and/or the properties of the substrate 40, such as the glow and reflection of a pearl or nacre substrate 40. Gemstones 20 set in this manner, using only posts 30, may display enhanced colour and brilliance, which can enhance aesthetic appeal and perceived value of the item of jewellery 10. This effect can be particularly enhance where in the substrate 40 is configured to be white, semi-translucent and/or curved.

The disclosed item of jewellery 10 may minimise consumption of precious metals in which can limit production costs. Also, the absence of adhesives in contact with the gemstone 20 avoids potential colouration of the gemstone 20 caused by discolouration of adhesives over time. The disclosed principles may reduce the required size of the recess 46, and may prevent or hide chipping to the edge of the recess 46, which can further enhance durability and/or aesthetic appeal. Further, gemstones 20 may be positioned to cover imperfections in a pearl substrate 40, thereby enhancing the perceived quality of the pearl. Furthermore, the method according to the present disclosure may broaden the scope of jewellery designs able to be embodied in the item of jewellery 10.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. An item of jewellery including:
a gemstone defining a peripheral region;
a plurality of posts; and
a substrate defining a plurality of apertures spaced in locations arranged relative to the peripheral region, each aperture dimensioned to receive a portion of one of the posts,
wherein the posts are secured in the apertures to extend from the substrate and against the peripheral region to mount the gemstone on the substrate.

2. The item of jewellery of claim 1, wherein the gemstone defines an axis of symmetry, and each aperture extends transversely to the axis.

3. The item of jewellery of claim 1, wherein the gemstone defines a plane of symmetry, and each aperture extends transversely to the plane.

4. The item of jewellery of claim 1, wherein the substrate has a notional mount region corresponding with the peripheral region, and the apertures are arranged to be at least partially within the notional mount region of the substrate.

5. The item of jewellery of claim 4, wherein the apertures are arranged in a regular array about the notional mount region.

6. The item of jewellery of claim 4, wherein a recess is defined within the notional mount region and shaped to partially receive the gemstone.

7. The item of jewellery of claim 1, wherein each post is shaped to trap a portion of the peripheral region.

8. The item of jewellery of claim 1, wherein each post defines an engaging portion configured to engage with the peripheral region.

9. The item of jewellery of claim 8, wherein each engaging portion includes a notch shaped to receive part of the peripheral region.

10. The item of jewellery of claim 1, wherein the gemstone defines a table facet, and wherein the posts are arranged to mount the table facet substantially parallel to the substrate.

11. The item of jewellery of claim 1, wherein each aperture is configured to frictionally engage one of the posts to retain the post to the substrate.

12. The item of jewellery of claim 1, wherein one or more of the apertures carries adhesive configured to bond the post to the substrate.

13. An item of jewellery including:
a plurality of gemstones, each gemstone defining a peripheral region;
a plurality of sets of posts; and
a substrate defining a plurality of sets of apertures, each set of apertures having the apertures spaced in locations arranged relative to the peripheral region of one of the gemstones, each aperture dimensioned to receive a portion of one of the posts, wherein each set of posts are secured in one of the sets of apertures to extend from the substrate and against the peripheral region of one of the gemstones to mount the gemstone to the substrate.

14. The item of jewellery of claim 13, wherein the substrate defines a curved surface, and each aperture is defined in the curved surface.

15. The item of jewellery of claim 14, wherein the substrate defines a double curved surface.

16. The item of jewellery of claim 14, wherein the substrate defines a substantially spherical structure.

17. The item of jewellery of claim 14, wherein the substrate is a pearl.

18. The item of jewellery of claim 4, wherein the substrate defines a planar surface, and each aperture is defined in the planar surface.

19. A method of mounting a gemstone defining a peripheral region to a substrate, the method including:
selecting a notional mount region on the substrate, the notional mount region substantially corresponding to the peripheral region of the gemstone;
selectively removing material from the substrate to define a plurality of holes in the substrate, the holes spaced in locations arranged relative to the notional mount region;
fixing a post in each hole such that a portion of the post is engaged with the substrate, and the post extends from the substrate; and
arranging the peripheral region of the gemstone against each of the posts such that the gemstone is retained within the posts.
